(19) United States
(12) Patent Application Publication
(10) Pub. No.: US 2006/0005644 A1
(43) Pub. Date: Jan. 12, 2006

(54) Multidirectional Linear Force Converter

(76) Inventor: Richard Lee Weaver, Falconer, NY (US)

Correspondence Address: RICHARD L. WEAVER, 304 EAST ELMWOOD AVENUE, LOT 12, FALCONER, NY, 14733, US

(21) Appl. No.: 10/710,415

(22) Filed: Jul. 8, 2004

(51) Int. Cl. F16H 35/00

(52) U.S. Cl. 74/84 S

(57) ABSTRACT

This is a device that controls centrifugal force to produce variable linear force in a direction that may be altered at any time by the operator. All moveable parts ride on bearings, and the negative forces that are created by rotating the weighted arms inward are counteracted by other weighted arms rotating outward, or positive forces, so that the device can operate on a relatively small power supply. The device is comprised of a fixed single Main shaft which is attached to the frame. Said shaft has two collars held in place by bearings, thus are independent of said shaft. Each collar has a sprocket attached to it and is controlled by an outside means. One collar is a drive collar that will rotate continuously at a set speed. The second collar is a steering collar which will remain in a fixed position until the operator decides to adjust speed or course. The drive collar has at least 4 Primary arms that extend perpendicular from the Main shaft. Attached to the end of each Primary arm are two Secondary arms, which rotate in a parallel plane to that of the Primary arms, one being above it and one below it. There are then Weights attached to the ends of the Secondary arms to create mass. The Steering collar controls the Secondary arms by using chain and sprockets that are on a 1:1 ratio. Therefore, every time the Primary arm completes one cycle around the Main shaft, the Secondary arms also complete one cycle around the end of the Primary arm. As long as the Steering collar remains in a stationary position the following will occur. If both the Primary arm and Secondary arms are facing an Easterly direction in a way that the weights, or mass, are fully extended Eastward then: When the Primary arm rotates 90 degrees to the North the Secondary will also rotate 90 degrees off the end of the Primary shaft. Therefore though the Primary arm is now facing North the Secondary arm is still facing East due to the connecting 1:1 ratio of the stationary Steering collar. As the Primary arm continues rotating another 90 degrees and faces West, the Secondary arm continues rotating 90 degrees and still faces East. The weights, or mass, are now located much closer to the Main shaft than when the Primary arm was facing East. Therefore, you are in essence, controlling the radius of a rotating object, lengthening it in one direction while shortening it in the other. Since centrifugal force is directly relational to it's radius, you will create more force in one direction than you will in the other, therefore creating linear force.

### SUMMARY OF INVENTION

This invention relates to an apparatus that converts centrifugal force into useable linear force. This is accomplished by rotating a set of Weights that are connected to a Secondary arm, around the extended end of a Primary arm, which in turn rotates around a Shaft. In this manner you can make the distance between the Shaft and the Weights, or the radius, greater on one side of the circular path than the other. Since centrifugal force is directly related to the length of the radius, you will be creating a motion that creates more centrifugal force on one side of the weights circular orbit than the other. When you create a greater centrifugal force in one direction than the other you will create linear energy.

All circular motion occurs in parallel planes to one another. Because of this it is possible to operate multiple units off the same shaft. These units should run in pairs, with one unit rotating in one direction and the other in the opposite. This will prevent rotational torque from being applied to the frame of the vehicle or craft. In addition a brake system can be attached to the frame to counteract with the Drive collar. This would become more essential if the craft is to be used for airborne purposes. The brake would be used as a back-up safety device. If for some reason one Drive collar created more resistance than the other Drive collars, you could then apply an amount of resistance on the opposite spinning Drive collar that would counteract the original resistance.

Each unit also has a Steering collar which controls the direction that the Secondary arms and Weights will face when they are fully extended away from the Primary arm. This allows the operator to control the direction of the linear force that is to be applied for that unit. By having the ability to stack these units on one another it allows you to control multiple forces. Controlling multiple forces also allows controlling multiple functions. Some examples are as follows and pictured in FIG. 4.

(FIG. 4. Sec. A) You may exert force in one direction with one unit and use the other unit to exert force in the opposite direction. This will allow the vehicle to sit idle without having to start and stop the arms from spinning. This is important, since everything runs on bearings, and arms that are moving inward are counteracted by arms that are moving outward, it requires minimal energy to keep everything rotating up to speed. However, stopping and starting the spin of the devices would require a far greater force, and it is an object of this design to create a large amount of force by using a very small amount of energy.

(FIG. 4 Sec. B) To begin momentum simply rotate opposite forces toward a perpendicular point of desired direction, then simultaneously rotate opposite forces toward your desired direction. As you draw these two forces together your linear force will increase until maximum force is obtained by having both forces concentrated in a single direction as shown in (FIG. 4 Sec. C).

(FIG. 4 Sec. D) To stop vehicle, simply rotate forces to opposite directions again and continue so that the desired force is created in the opposite direction to that in which you are going. Once vehicle is stopped apply forces as described in example 1 (FIG. 4 Sec. A).

(FIG. 5) With the use of many units you may alter the forces on the top half of the shaft as to that of the bottom. This would allow you to obtain a desired pitch of the craft to obtain a desired altitude.

Most propulsion systems react off from a stationary substance such as air or water. Whether you use a propeller to push or pull the craft, or burn rocket fuel to push the craft, or whatever, you still will only obtain a certain speed that is relative to the amount of push or pull that you can create against your stationary force minus the amount of friction your craft creates going through your stationary substance. This device reacts off centrifugal force and not a stationary substance, therefore, regardless if you are traveling 10 MPH, 100 MPH or 1,000 MPH you will still create the same amount of acceleration, minus the amount of friction your craft creates going through the medium.

### BRIEF DESCRIPTION OF DRAWINGS

FIG. 1: Depicts two units stacked on one another. The numbered parts that comprise the upper unit have the letter “U” following the numbered part. The lower unit uses the letter “L”.

FIG. 2: Depicts a 3D view of a single unit to better view how the secondary arms are tied together by the steering chain and sprockets and how the Secondary arms are set up.

FIG. 3: Depicts a top view showing the rotation of the primary arms in correlation with the secondary arms and how the secondary arms are set up to face the same direction.

FIG. 4: Depicts how you can use two different forces from two units to perform other functions.

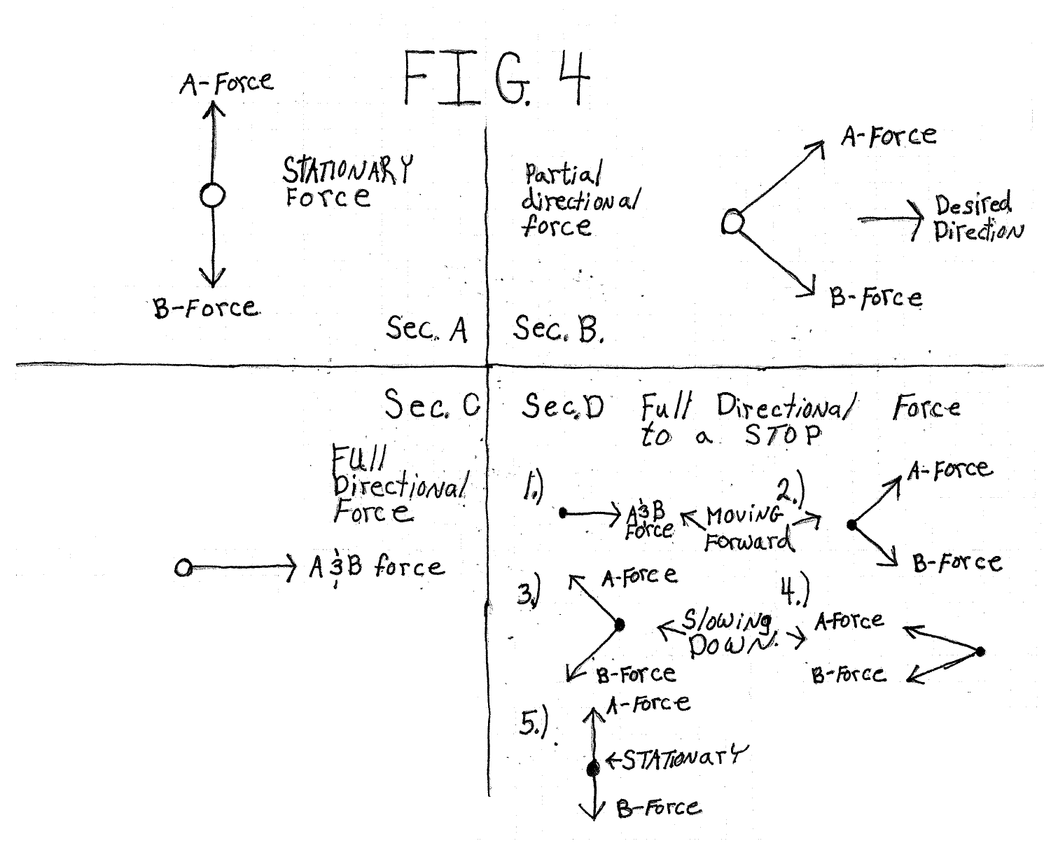

FIG. 5: Depicts how you can use multiple forces to control the pitch of an aircraft or spaceship.

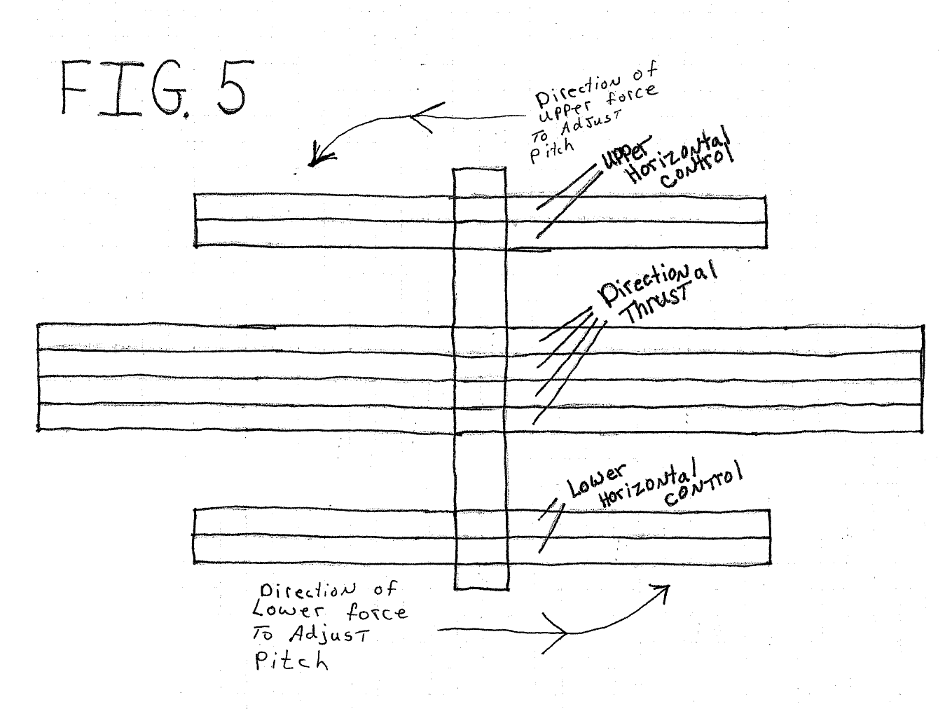

### DETAILED DESCRIPTION

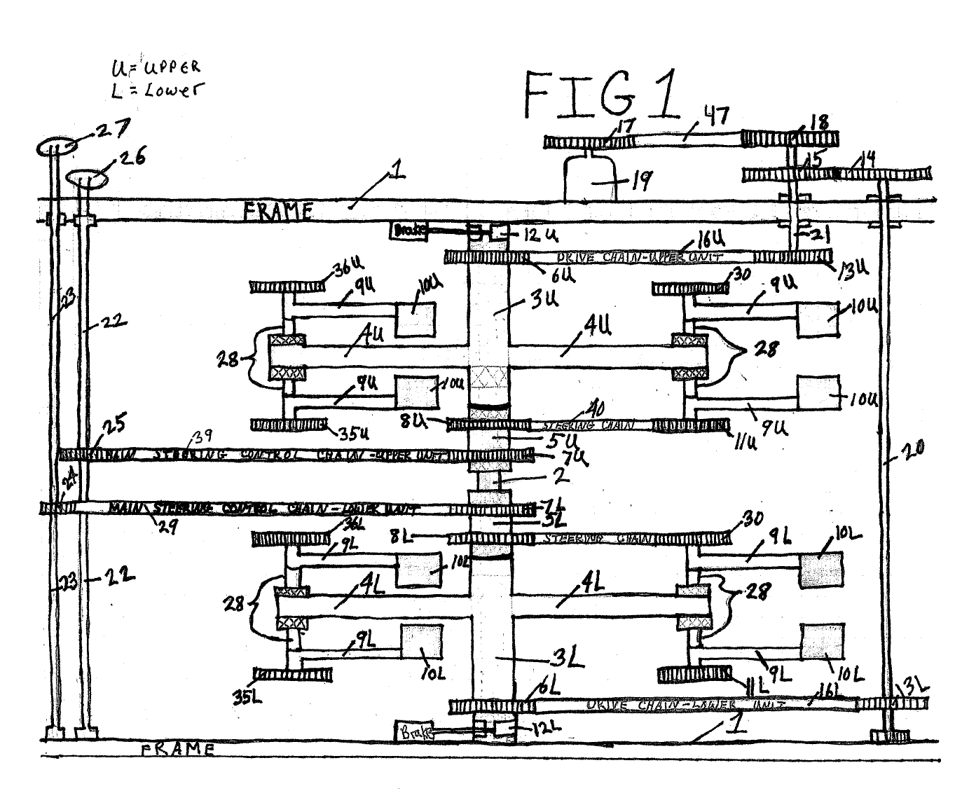

The present device will be explained in detail using the two units shown in FIG.1, unless otherwise directed.

There is a Main shaft (2) which is connected at each end to the frame (1) of the craft to be used.

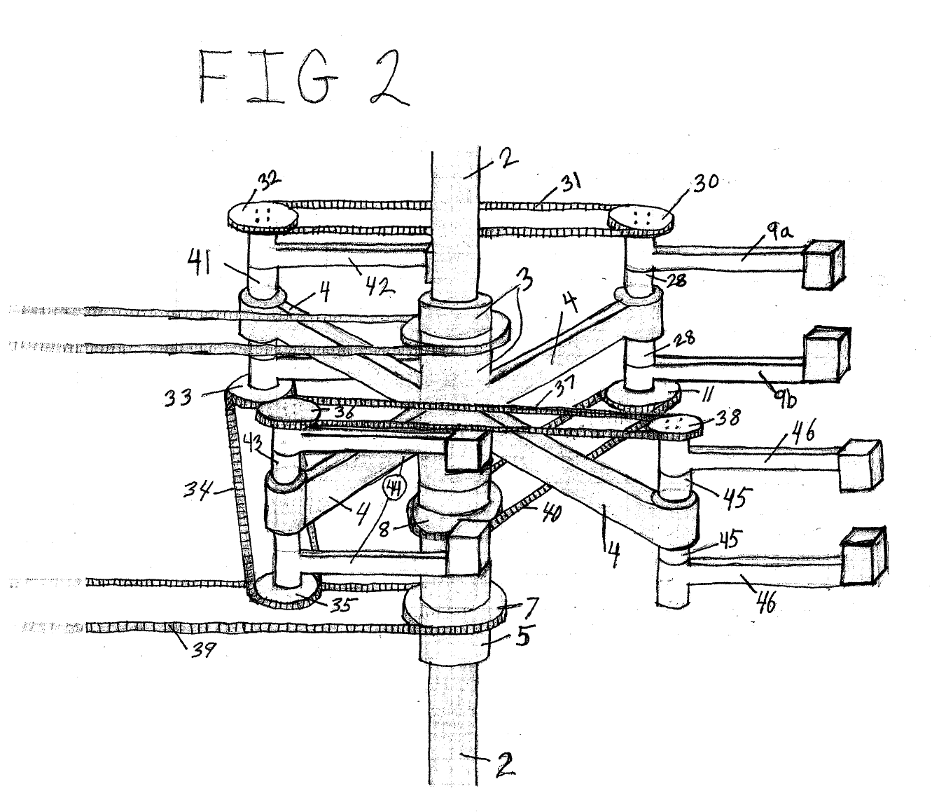

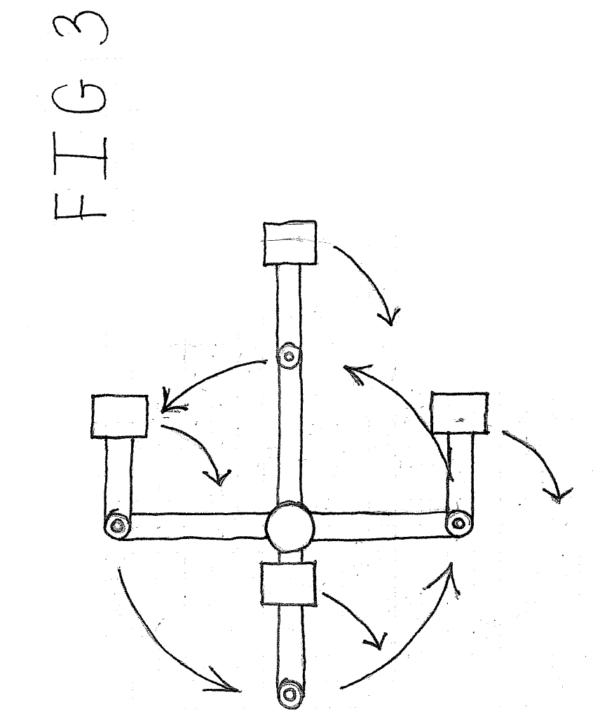

Also connected to the frame is a Power source (19) such as an electric motor. This power source use two sprockets (17, 18) connected by chain (47) to drive the upper Power shaft (21). As the upper Power shaft (21) rotates, it drives the lower Power shaft (20) in an opposite direction of the upper Power shaft (21) by using gears (15, 14). This allows the upper and lower units to rotate in opposite directions at equal speeds so as not to create a rotational torque against the Frame (1). Each Power shaft (20, 21) in turn rotates a Drive collar (3) by using sprockets (6, 13) and a chain (16). The Drive collar (3) is connected to the Main shaft (2) by bearings (not pictured), thus is independent from said shaft. The Drive collar (3) has four Primary arms (4) that are welded to the Drive collar (3) in so that they extend in a perpendicular position and are positioned in 90 degree intervals around the Drive collars (3) as shown in FIG. 2. In this way when the Drive collars (3) rotate, so do the four Primary arms (4). There are two secondary arms (9) that are attached to the extended end of the Primary arm (4) by a Pivot shaft (28). The Pivot shaft (28) is attached to the Primary arm (4) by bearings (not shown). The Pivot shaft (28) is mounted parallel to the Main shaft (2) in that it allows the Secondary arms (9) to rotate in a parallel plane to the rotating Primary arm (4). One Secondary arm (9) will rotate in a plane above the Primary arm (4) and the other in a plane below it. Attached to the far end of the Secondary arms (9) are Weights (10) to create Mass. All Secondary arms (9) will be laid out to face the same direction, regardless of the direction that the Primary arm (4) that it is attached to is facing, as pictured in FIGS. 2 and 3. In other words, if one Secondary arm (9) faces an Easterly direction then all the Secondary arms are also facing Easterly. Furthermore, as the Primary arms (4) rotate around the Main shaft (2), the Secondary arms (9) will counter rotate with the Pivot shaft (28) to continuously maintain an Easterly direction. In this way when the Primary arm (4) and the Secondary arm (9) both face East then the Weights (10) are positioned at their furthest point possible from the Main shaft (2). However, once the Primary arm(4) rotates 180 degrees and faces West, the Secondary arm (9) will counter rotate 180 degrees off the end of the Primary arm (4) and thus will still be facing East. This will be explained in further detail as we go through the Steering mechanism.

The Steering mechanism begins at the Steering wheel (26), which remains in a stationary position until the operator decides to alter the course of the linear force of the unit that is being controlled by that Steering wheel (26). This would be much like holding the steering wheel still while driving a car down a straight road. Once the operator decides to alter the direction of the linear force he will turn the Steering wheel (26). This turns the Steering shaft (22) which turns the Steering shaft sprocket (25) that is attached to it. The Steering shaft sprocket (25) is attached to the Steering control sprocket (7) by the Steering control chain (39). The Steering control sprocket (7) is attached to the Steering collar (5). The Steering collar (5) is attached to the Main shaft (2) by bearings (not shown). Therefore the Steering collar (5) is independent from the Main shaft (2) and is controlled by the Steering wheel (26) as described above. It is this Steering collar (5) that controls the rotation of all the Secondary arms (9). Refer to FIG. 2 for the following. The Steering collar (5) controls the Pivot shaft (28) by using two sprockets (8, 11) and a chain (40). The two sprockets (8, 11) have the same number of teeth, thus have a 1:1 ratio. The Pivot shaft (28) has two Secondary arms (9a, 9b) and another sprocket (30) connected to it as shown. If the Secondary arms (9) are facing East and you rotate the Steering collar (5) 180 degrees, the Secondary arms (9) will also rotate 180 degrees and now face West. If nothing has been rotated and the Secondary arms are all still facing East, then as the Drive collar (3) and Primary arms (4) rotate around the Main shaft(2), and the Steering collar (5) remains stationary, then the Secondary arms (9) will remain fixed in an Easterly direction regardless of how the Primary arms (4) are changing directions. The Steering collar (5) and sprocket (8) are stationary. However, as the Primary arm (4) completes a full revolution, the chain will rotate around the sprocket (8). This reacts on the other sprocket (11) which controls the Pivot shaft (28) and Secondary arms (9). The reaction is such that, for every degree that the Primary arm (4) rotates, the Pivot shaft (28) and Secondary arms (9) will counter rotate 1 degree. Therefore keeping the Secondary arms (9) facing the desired direction. In other words, if the Primary arm (4) faces East, and the Secondary arms (9) are extended East also, then once the Primary arm (4) rotates 180 degrees and faces West, the Secondary arm (9) will have counter rotated off the end of the Primary arm (4) 180 degrees and will still be facing East. This places the Mass much closer to the Primary point of rotation being the Main shaft (2), therefore decreasing the radius. Since the radius is directly relational to the amount of centrifugal force created, then extending the radius in one direction, while shortening it in the opposite, will create more force in one direction than the other, thus creating linear force. All the Primary arms (4) and Secondary arms (9) create this motion and effect since they are all connected together through chains and sprockets in a pattern that is set-up so as they rotate they will exert force in the same direction. They are connected as follows: Sprocket (11) controls pivot shaft (28) and attaching Sprocket (30). Sprocket (30) controls Sprocket (32) with chain (31). Sprocket (32) controls it's Pivot shaft (41) and the Sprocket (33). Pivot shaft (41) directs the Secondary arms (42) in the desired direction. Sprocket (33) controls Sprocket (35) using chain (34). Sprocket (35) controls it's Pivot shaft (43) and Sprocket (36). Pivot shaft (43) directs the Secondary arms (44) toward the desired direction. Sprocket (36) in turn controls Sprocket (38) by chain (37). Sprocket (38) controls Pivot shaft (45) which directs its Secondary arms (46). All arms and weights extend and contract in their desirable locations since they are all linked together with chain and sprockets. Once more, by turning the Steering wheel you relocate the direction in which the arms and weights extend and contract.

Everything being tied together offers other unseen benefit, such as: As the Secondary arms (9) and weights (10) move beyond their fully extended position they begin to create a negative force against the device due to rotating the arms and weights inward against the centrifugal force. By having multiple weights and arms attached to one another you can counteract this negative force with the positive force created from the arms and weights that are extending out. Without the multiple arms and weights, you would require more power to run the device and it would create a pulsating motion.

1. A drive unit that creates centrifugal force by using an outside power source that rotates a Drive Collar. Said Drive Collar has multiple Primary arms that are attached and extend outward in perpendicular angles and are evenly spaced apart. Inside the said Drive Collar are bearings that allow the Drive Collar and Primary Arms to spin in a perpendicular plane around a Fixed Shaft that is attached to the Frame. Attached to the extended end of each Primary Arm are bearings and a Pivot Shaft that offer an axis for rotation to at least one Secondary arm but preferably two. These Secondary Arms revolve in a parallel plane to that of the Primary Arm, one being above it and the other being below it. Each Secondary Arm has a weight attached to it's extended end to create mass.

2. A Steering Collar which directs the majority of the centrifugal force created toward a desired direction by counter rotating the Secondary Arms, described in claim 1, to that of the Primary Arms, also described in claim 1, in a 1:1 ratio against each other. Therefore for each cycle the Primary Arm completes, the Secondary Arm will complete an opposite cycle off the end of the Primary arm. Since the Secondary Arms revolve in an opposite direction off of the ends of the rotating Primary Arms in an equal manner, a condition is created where as although the Secondary Arms are rotating around an axis their linear direction remains the same. In other words, if the weights on the Secondary arm are in an Easterly direction of it's axis, then regardless of what direction the Primary Arms rotate and face the weights on the Secondary arm remain facing East. This condition will fully extend both arms when the Primary arm faces East and completely fold the Secondary arms in upon the Primary Arm when it faces West, thus making the radius between the Fixed Shaft and the weights longer when facing East than when facing West, creating more centrifugal force in one direction than the other. The 1:1 ratio between the Steering Collar and the Secondary arms can be generated by any means, to include but not limited to, using two sprockets with the identical number of teeth and a chain. One sprocket encompasses the said Steering collar, and the other being attached to the axis of the Secondary arm, with both sprockets being connected by said chain. In this way if the Steering collar remains fixed, as the Primary Arm rotates around the Fixed shaft, the axis of the Secondary Arm will be forced to counter rotate against the Primary Arm.

3. The Steering collar described in claim 2 is attached to the Fixed Shaft by bearings. An outside source holds the steering collar in a fixed position to maintain it's course, or rotates it to a different position to alter the point where the Primary Arms and Secondary Arms extend and fold in as described in claim 2. This will change the direction of the linear force.

4. Multiple units may be stacked on one another since all parts are independent from the Fixed Shaft. Units can then rotate in opposite directions at equal speeds so as not to create a rotational torque against the Frame of the craft being operated. Multiple units may also work together to create further functions such as to stop, go backwards, or to control the pitch of a craft.
